(19) United States
(12) Patent Application Publication
(10) Pub. No.: US 2004/0163970 A1
(43) Pub. Date: Aug. 26, 2004

(54) Test cartridge, system for sensing fluid, and methods

(75) Inventors: Kee Van Sin, Lino Lakes, MN (US); Martin Gaines Hieb, Plymouth, MN (US); James Donald Kurkowski, Roseville, MN (US); Scott Everett Blomberg, Plymouth, MN (US)

Correspondence Address: FISH & RICHARDSON P.C., 3300 DAIN RAUSCHER PLAZA, 60 SOUTH SIXTH STREET, MINNEAPOLIS, MN, 55402, US

(73) Assignee: Diametrics Medical, Inc.

(21) Appl. No.: 10/370,557

(22) Filed: Feb. 20, 2003

(51) Int. Cl. G01N 27/26

(52) U.S. Cl. 205/792; 204/412; 204/403.01; 204/416; 204/424; 205/789

(57) ABSTRACT

A cartridge for analyzing a bodily fluid for use with an analytical device includes a base structure, a sensor arrangement, a pump arrangement, and a pump control arrangement configured to selectively operate the pump when the cartridge is operatively positioned in the analytical device. A system for analyzing a bodily fluid includes an analytical device with a cartridge-receiving receptacle and a cartridge operatively and removably mounted in the cartridge-receiving receptacle. The cartridge includes a sensor arrangement and a pump. The analytical device includes a pump control arrangement to selectively operate the pump. A method of analyzing bodily fluid includes inserting a cartridge into an analytical device, dispensing a sample into the cartridge, sensing the fluid with the cartridge, and allowing the analytical device to automatically pump a calibration fluid over sensors in the cartridge.

### TECHNICAL FIELD

This disclosure is directed generally to portable analytical devices and cartridges usable therein.

This disclosure is a continuing development of Diametrics Medical, Inc. of Roseville, Minn. The disclosure is an improvement over U.S. Pat. No. 5,968,329 assigned to Diametrics Medical, and incorporated herein by reference.

### BACKGROUND

U.S. Pat. No. 5,968,329 disclosed a system including an analytical device unit with a multi-sensor plug in cartridge. The cartridge featured a plug-in module including a reusable sensor cartridge having an inlet port for receiving a sample. The analytical device was also configured for receiving a single-use sensor cartridge interchangeably and without modification with the plug in multi-use test module. Improvements in such systems are desirable.

### SUMMARY

A cartridge for analyzing a bodily fluid for use with an analytical device includes a base structure, a sensor arrangement, a pump arrangement, and a pump control arrangement configured to selectively operate the pump when the cartridge is operatively positioned in the analytical device.

A system for analyzing a bodily fluid includes an analytical device with a cartridge-receiving receptacle and a cartridge operatively and removably mounted in the cartridge-receiving receptacle. The cartridge includes a sensor arrangement and a pump. The analytical device includes a pump control arrangement to selectively operate the pump.

A method of analyzing bodily fluid includes inserting a cartridge into an analytical device, dispensing a fluid sample into the cartridge, sensing the fluid with the cartridge, and allowing the analytical device to automatically pump a calibration fluid over sensors in the cartridge.

### BRIEF DESCRIPTION OF THE DRAWINGS

FIGS. 1-6 show schematic diagrams of a reusable test cartridge during various phases of use;

FIG. 7 illustrates a schematic diagram of a control assembly on the analytical device for controlling certain aspects of the reusable cartridge;

FIG. 8 is a perspective view showing the analytical device with the reusable cartridge mounted thereon;

FIG. 9 is a perspective view of the analytical device with the reusable cartridge disassembled from the analytical device; and

FIG. 10 is a perspective view showing the analytical device with a single-use cartridge being mounted therein.

### DETAILED DESCRIPTION

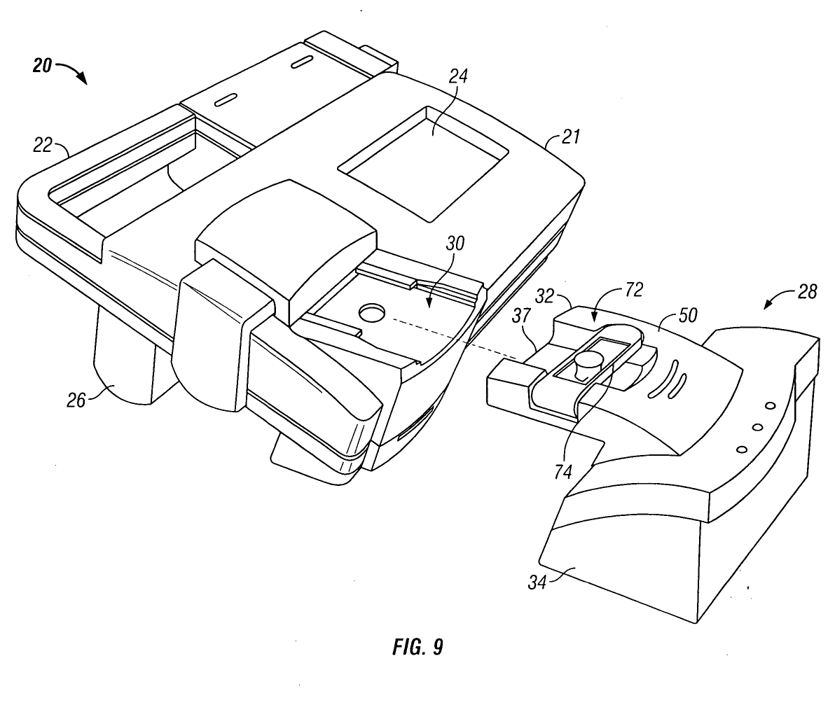

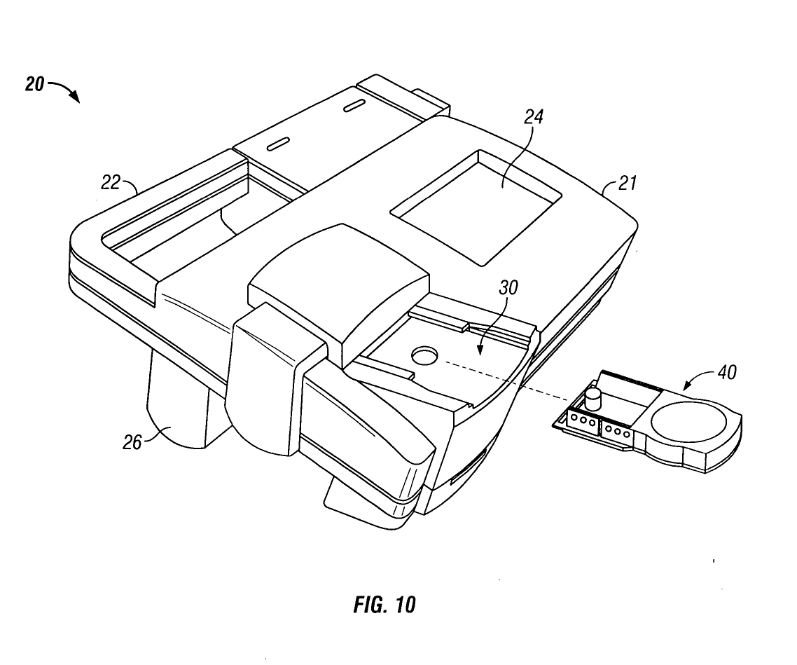

Reference is first made to FIGS. 8-10. In FIGS. 8-10, a perspective view of a portable analytical device is shown generally at 20. The device includes an external housing 21 that forms a carrying handle 22. An opening covered with a transparent cover 24 houses an LCD or other type of human readable output display. The system further includes a battery case at 26, a printer system (not shown) and a multiple-use test cartridge system or module 28 is shown attached and received within a cartridge receptacle receiving area 30 (FIGS. 9 and 10).

FIG. 9 shows the multi-use test cartridge 28 detached from the analytical device 20. The multi-use cartridge 28 is configured with a snap-fitting member 32 and a stabilizing support footing member 34. The cartridge plug interface is shown at 37 and is identical with single-use cartridges 40 (FIG. 10). Single-use cartridges 40 may be the type described in U.S. Pat. No. 5,325,853, incorporated herein by reference, and commonly assigned U.S. patent application Ser. No. 10/160,329 filed May 30, 2002, incorporated herein by reference. By the term “single-use,” or variants of this term, it is meant that after performing an analysis of bodily fluid from a single sample, the cartridge 40 is disposed of, or discarded. This is in contrast to the multiple-use or reusable cartridge 28. By the term “multiple-use,” “multi-use”, “reusable” or variants of these terms, it is meant that the same cartridge can be used to perform analysis on multiple, separate, and distinct samples of bodily fluid. As used herein, the term “sample” means a defined quantity of fluid to be tested from a single source, for example, often in the form a syringe, collection tube, or container holding bodily fluid from a test subject (patient, for example.) The analytical device can be constructed in accordance with U.S. Pat. No. 6,066,243, incorporated herein by reference. It may utilize principles in accord with U.S. Pat. Nos. 5,223,433; 6,060,319; and 5,232,667, each of which is incorporated herein by reference. One type of usable analytical device 20 is commercially available from Diametrics Medical, Inc., Roseville, Minn., under the brand name IRMA Blood Analysis System.

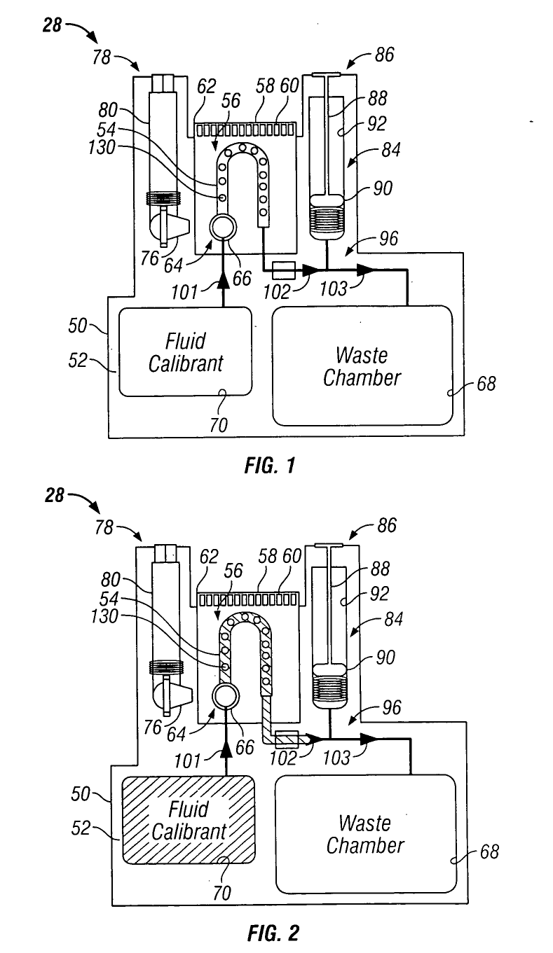

Still in reference to FIGS. 8 and 9, the preferred multiple use cartridge 28 includes a base structure 50. The base structure 50 is preferably constructed of a polymer material such as polycarbonate. The base structure 50 holds or is a housing for a substrate 52 (FIGS. 1-6). In preferred applications, the substrate 52 is a ceramic substrate.

The base structure 50 defines at least one fluid channel 54 (FIGS. 1-6), which accommodates a sensor arrangement 56 therein. By “sensor arrangement,” it is meant at least one sensor or a plurality of sensors is contained within the fluid channel 54. The sensors within the sensor arrangement 56 can be many different types of sensors including, for example, wet-stored, dry-stored, liquid-calibrated, non-liquid calibrated, or not calibrated at all. A sensor that is stored in a solution is a wet-stored sensor. A sensor that is not stored in a solution is a dry-stored sensor. Of wet-stored sensors and dry-stored sensors, there can be ion selective electrode (potentiometric) sensors, amperometric sensors, conductometric sensors, and enzymatic sensors.

If the fluid sample is a bodily fluid, such as blood, typical useable constructions may include ion selective electrode sensors to measure pH and pCO₂. One type of pO₂ sensor may be an amperometric sensor. For blood electrolytes, for example sodium sensors, calcium sensors, and potassium sensors, these can be ion selective electrode sensors. Hematocrit may be measured using, for example, a conductometric sensor. Chloride may be measured, in many typical implementations, with an ion selective electrode sensor. Glucose, blood urea nitrogen (BUN), and creatinine may be measured utilizing, for example, enzymatic sensors. To measure blood coagulation, one type of sensor usable may be a conductometric sensor.

With many types of sensors, calibration is needed for the sensors in order to obtain an accurate measurement.

The cartridge 28 further includes a conductor arrangement 58 (FIGS. 1-6) in electrical contact with the sensor arrangement 56. The conductor arrangement 58, and the one shown, includes an array of functional electrical conductors 60. The conductors 60 allow for electrical communication between the cartridge 28 and the analytical device 20 and include input and output conductors. The conductors 60 are constructed in accordance with conventional techniques. In the example shown, they are deposited on the surface of the substrate 52. In the preferred implementation shown in FIGS. 1-6, the conductors 60 are adjacent to an edge 62 of the cartridge 28, allowing the cartridge 28 to be adaptable in use with edge connectors.

The cartridge 28 includes a port arrangement 64 (FIGS. 1 and 2) in fluid communication with the fluid channel 54. The port arrangement 64 allows for selective insertion of selected fluids into the fluid channel 54. In the example shown in FIGS. 1 and 2, the port arrangement 64 includes an inlet port 66 that permits selective introduction or insertion of fluid to be tested (e.g., bodily fluid) into the fluid channel 54.

The cartridge 28 further includes a waste reservoir or chamber 68 (FIGS. 1-6). The waste chamber 68 is depicted as being in fluid communication with the fluid channel 54. In use, the waste chamber 68 collects and contains used fluids in the cartridge 28. Such used fluids include, for example, used calibration fluid and bodily fluid, such as blood.

In FIGS. 1 and 2, the inlet port 66 is shown located between a first fluid chamber or reservoir 70 and the fluid channel 54. In preferred embodiments, the first fluid reservoir 70 contains calibration fluid therein. The calibration fluid is a fluid selected appropriate for the types of sensors in the sensor arrangement 56. Typical calibration fluid usable will be an aqueous solution with the appropriate amount of test materials. That is, for each of the sensors in the sensor arrangement 56, there will be a material in the calibration fluid to allow for a test measurement. During calibration, the calibration material flows into the fluid channel 54 and contacts the sensor arrangement 56. Selected ones of the sensors in the sensor arrangement 56 are then calibrated based upon the known quantity of materials in the calibration fluid.

In reference now to FIGS. 8 and 9, the inlet port 66 is preferably selectively opened and closed by a cover arrangement 72. The cover arrangement 72 is controllable for the selective opening and closing (uncovering and covering) the inlet port 66. In the particular preferred embodiment shown, the cover arrangement 72 includes an arm 74 in selective moveable engagement with the inlet port 66. In FIG. 8, the arm 74 is shown in covering engagement with the inlet port 66. In phantom lines, in FIG. 8, the arm 74 is shown in a position pivoted away from the inlet port 66. Thus, in phantom, the inlet port 66 is open or uncovered.

As can be seen in FIG. 8, the arm 74 is preferably pivotable or rotatable with respect to a plane containing the substrate 52. In preferred embodiments, the arm 74 is rotatable from a position coextensive with the substrate 52 (and in covering relation to the inlet port 66) to a position orthogonal to the substrate 52 (phantom lines of FIG. 8). FIG. 9 shows the arm 74 in a position such that the cover arrangement 72 is covering the inlet port 66.

In preferred embodiments, the cover arrangement 72 includes a seal member 76 (FIGS. 1 and 2) to selectively form a seal with the inlet port 66. Some of the reasons for forming a seal between the arm 74 and the inlet port 66 are described further below.

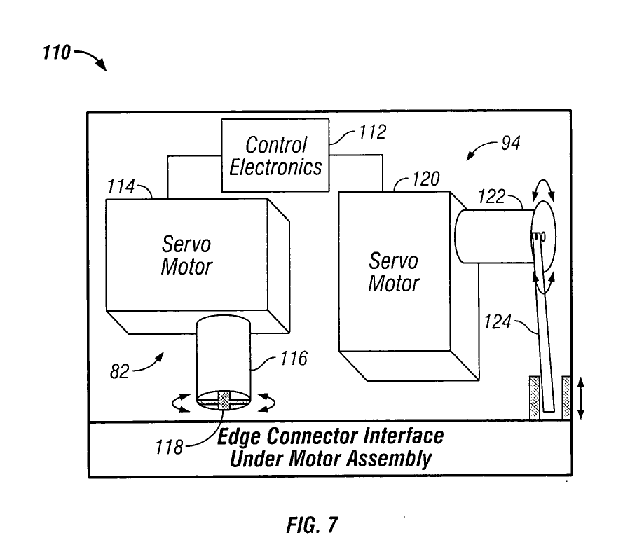

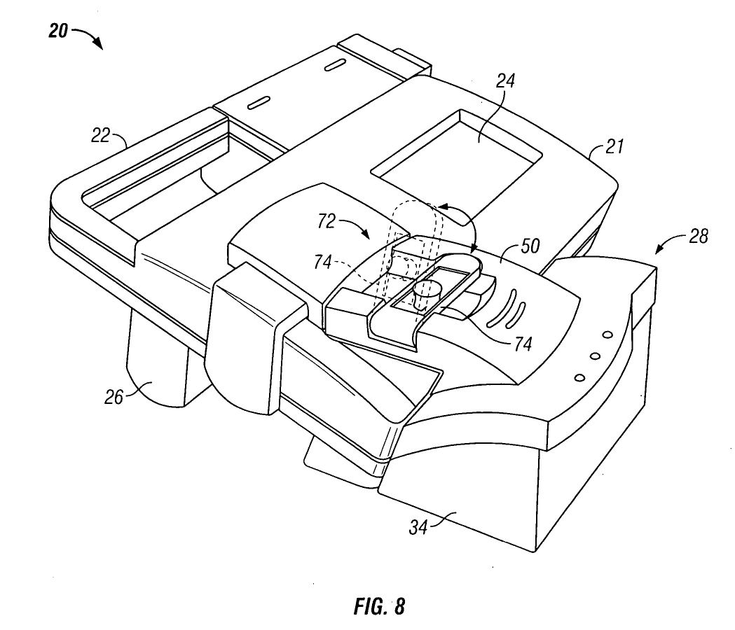

The arm 74 is part of a cover control arrangement 78 on the cartridge 28. The cover control arrangement 78 selectively opens and closes the inlet port 66 with the cover arrangement 72, when the cartridge 28 is operatively positioned in the analytical device 20. The preferred cover control arrangement 78 further includes a rotateable shaft 80 an operable connection with the arm 74. In preferred implementations, when the shaft 80 rotates, it will translate into a pivoting motion of the arm 74 including the cover arrangement 72. The cover control arrangement 78 interfaces with cover control arrangement structure 82 (FIG. 7) on the analytical device 20. This is described further below.

The cartridge 28 also preferably includes a pump arrangement 84 in fluid communication with the fluid channel 54. The pump arrangement 84 is also preferably in fluid communication with the first reservoir 70. The pump 84 operates to introduce appropriate forces within the cartridge 28 in order to convey fluid throughout the cartridge 28. This is described further below.

The cartridge 28 also preferably includes a pump control arrangement 86 configured to selectively operate the pump arrangement 84, when the cartridge 28 is operatively positioned in the analytical device 20. The pump control arrangement 86 on the cartridge 28, in the embodiment shown, includes a shaft 88 that operates to push a plunger 90 within a chamber 92. The plunger 90 is allowed to reciprocate within the chamber 92 in order to create the appropriate pressure differences and forces to convey the fluid.

The pump control arrangement 86 in the cartridge 28 interfaces with a pump control arrangement 94 (FIG. 7) in the analytical device 20. This is described further below.

Still in reference to FIGS. 1-6, the cartridge 28 further includes a valve arrangement 96 to allow for a desired flow path of the fluid within the fluid channel 54. Preferably, the valve arrangement 96 includes a first valve 101 in the fluid path 54 to prevent fluid from flowing from the inlet port 66 to the first reservoir 70. The valve arrangement 96 also preferably includes a second valve 102 in the fluid path 54 to prevent fluid from flowing from the pump arrangement 84 to the sensor arrangement 56. Further, the valve arrangement 96 preferably includes a third valve 103 in the fluid path 54 to prevent fluid from flowing from the second reservoir 68 to the pump arrangement 84. In preferred embodiments, the first valve 101, second valve 102, and third valve 103 are each check valves.

As can be seen in FIGS. 1-6, in the preferred embodiment, the sensor arrangement 56 is downstream of the inlet port 66. The first reservoir 70, preferably containing calibration fluid, is located upstream of the inlet port 66 and the sensor arrangement 56. With the first valve 101 located in between, this means that fluid to be tested that is injected through the inlet port 66 is not allowed to flow backwards against the first valve 101 and into the first reservoir 70. Rather, the fluid to be tested is introduced through the inlet port 66 and can only flow in the direction toward the sensor arrangement 56.

Preferably, the waste chamber or reservoir 68 is downstream of the inlet port 66 and the sensor arrangement 56. Further, preferably, the pump arrangement 84 is downstream of the sensor arrangement 56 and upstream of the waste chamber 68. Note the location of the second valve 102 and third valve 103. The second valve 102 prevents fluid that is drawn into the pump chamber 92 from flowing back through the sensor arrangement 56. Rather, it must flow in a direction toward and into the waste chamber 68. The third valve 103 prevents fluid in the waste chamber 68 from being drawn into the pump chamber 92. Rather, when the pump arrangement 84 is operating, fluid can only flow in the direction from the fluid channel 54 in the section of the sensor arrangement 56, and further upstream, if the inlet port 66 is sealed closed by the cover arrangement 72.

In reference now to FIG. 7, a control system for automating operation of the cartridge 28 is shown generally at 110. The control system 110 is preferably included as part of the analytical device 20. The control system 110 includes appropriate control electronics 112 in operable communication with the cover control arrangement 82 and the pump control arrangement 94. The cover control arrangement 82, in the embodiment shown, includes a servo motor 114 controlling motion of a shaft 116. The shaft 116 has an adapter 118 for operably connecting with the shaft 80 on the cover control arrangement 78 of the cartridge 28. In operation, the servo motor 114 rotates the shaft 116, which, when the cartridge 28 is operatively connected to the analytical device 20, will rotate the shaft 80.

In the preferred embodiment, the pump control arrangement 94 also includes a servo motor 120. This servo motor 120 rotates a shaft 122, which translates into reciprocal linear motion of a crank 124. The crank 124 operably connects with the shaft 88 on the pump control arrangement 86 of the cartridge 28. In this manner, when the shaft 122 rotates, it drives the crank 124 in a reciprocating motion, which is translated into reciprocating motion on the shaft 88 thereby moving the plunger 90 within the chamber 92.

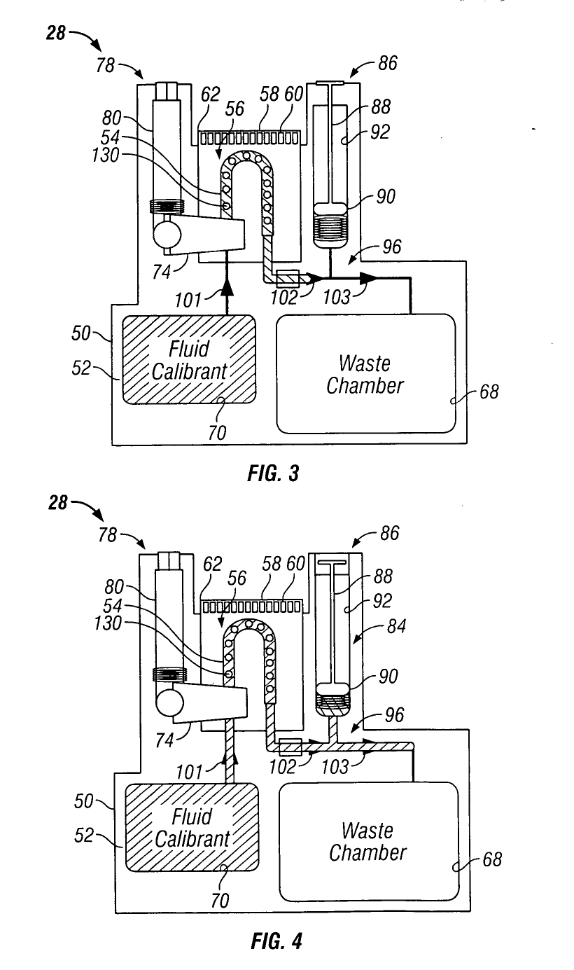

A method of analyzing fluid, such as bodily fluid, such as blood, can now be described with respect to the structure referenced herein. First, the reusable cartridge 28 is operably inserted into the receiving area 30 of the analytical device 20 (FIG. 2). A sample of bodily fluid is dispensed into the cartridge 28 through the fluid inlet port. This can be done by positioning a syringe containing the fluid sample into fluid communication with the inlet port 66 and then pushing the sample into the fluid channel 54. Because of the position of the first valve 101, the sample does not flow into the calibrant chamber 70; rather, it flows through the sensor arrangement 56. This is shown in FIGS. 2 and 3.

The fluid sample is then sensed with the sensor arrangement 56 in the cartridge 28.

Next in FIG. 4, the analytical device 20 is allowed to automatically pump calibration fluid over the sensor arrangement 56 in the cartridge 28. This is done without any interaction by the user. In particular, the analytical device 20 uses the electronics 112 to control the servo motor 120. The servo motor 120 moves the shaft 122, the crank 124, and moves the plunger 90 back and forth within the chamber 92. This pumping action operates to move calibration fluid from the first reservoir 70 through the fluid channel 54 and across the sensor arrangement 56. Bodily fluid, such as blood, that was present in the fluid channel 54 in the sensor arrangement 56 is displaced and pumped in the direction of the waste chamber 68.

In preferred methods, after the step of dispensing the sample of bodily fluid into the fluid inlet port 66, the analytical device 20 is allowed to automatically cover the fluid inlet port 66. This is done without manual interaction or manipulation by the user. In particular, the analytical device 20 uses the control system 110 to operate the servo motor 114. The servo motor 114 turns the shaft 116 and that turns the shaft 80. This pivots the arm 74 into a position so that the cover arrangement 72 closes the inlet port 66. (Compare FIGS. 2 and 3.) Preferably, the step of automatically covering the inlet port 66 includes allowing the analytical device 20 to automatically seal closed the inlet port 66. This is done by having the seal member 76 on the cover arrangement 72 move into tight, sealing engagement with the inlet port 66 (FIG. 3). This forms a seal between the cover arrangement 72 and the inlet port 66.

By forming the seal between the inlet port 66 and the cover arrangement 72, the pump arrangement 84, when operated, pumps the calibrant fluid from the first fluid reservoir 70 into the fluid channel 54 and across the sensor arrangement 56. This places calibrant fluid over the sensors in the sensor arrangement 56 and displaces the fluid sample (e.g., blood) into or in the direction of the waste chamber 68 (FIG. 4).

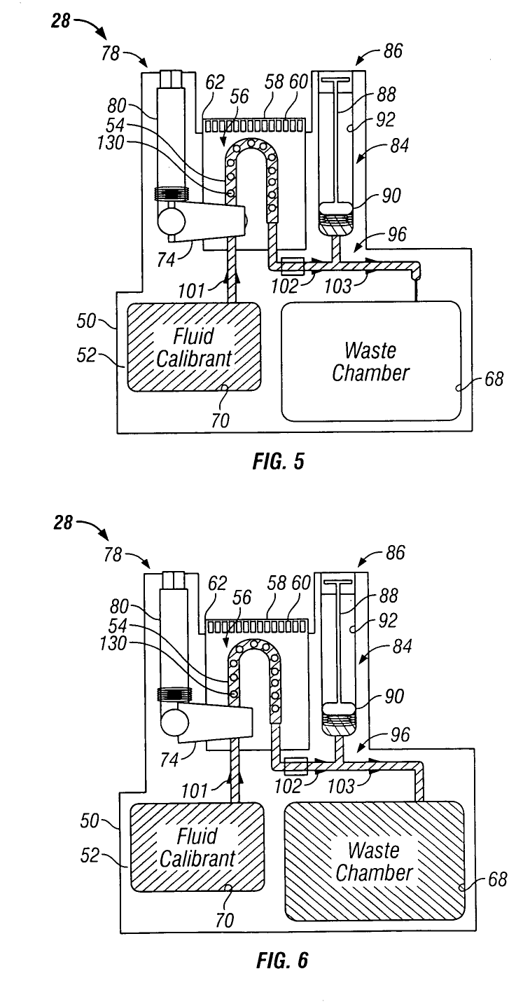

Preferably, after the step of allowing the analytical device 20 to automatically pump calibration fluid over the sensor arrangement 56 in the cartridge 28, there is a step of allowing the analytical device 20 to automatically vent the fluid inlet port 66. In preferred arrangements, this step includes the analytical device 20 using the control system 110 to activate the servo motor 114. The servo motor 114 will move the shaft 116, which will move the arm 74 into a position that breaks or releases the seal between the seal member 76 and the inlet port 66. In preferred arrangements, this will move the arm 74 out of sealing engagement with the fluid inlet port 66 a distance sufficient to vent the inlet port 66 and still cover the inlet port 66. This is shown in FIG. 5. This is done to prevent users from injecting further samples into the inlet port 66 while testing is still taking place with the original sample. The cover arrangement 72 is moved, however, a distance sufficient to allow for the flow of air through the inlet port 66. In other embodiments, it is foreseen that the step of allowing the analytical device 22 automatically vent the inlet port 66 would allow for the movement of the arm 74 in a variety of positions out of sealing engagement with the inlet port 66, including the position shown in phantom in FIG. 8.

After the step of allowing the analytical device 20 to automatically vent the fluid inlet port 66, there is preferably a step of allowing the analytical device 20 to automatically pump air into the fluid inlet port 66. This is done by allowing the control system 110 to activate the pump control arrangement 94. This includes the servo motor 120 moving the shaft 122 and the crank 124 to reciprocate the plunger 90 within the chamber 92. With the inlet port 66 being opened to the outside air, the pump arrangement 84 draws outside air into the inlet port 66. In preferred embodiments, a sufficient amount of air is drawn into the cartridge 28 just enough to cover the first sensor 130 that is immediately downstream of the inlet port 66. Preferably, this first sensor 130 is a sensor for the partial pressure of oxygen (O₂).

Preferably, after allowing the analytical device to automatically pump air into the fluid inlet port 66 and cover the first sensor 130 with air, there is a next step of sensing the calibration fluid and the air with the sensor arrangement 56 in the cartridge 28. In other words, in preferred implementations, after the sample is tested, the pump arrangement 84 automatically operates to pump calibrant in from the first reservoir 70 across the sensor arrangement 56 to displace the bodily fluid from the fluid channel 54 and into the waste chamber 68. Next, the inlet port 66 is automatically vented by automatic movement of the cover arrangement 72 from sealing engagement with the inlet port 66, and the pump arrangement 84 automatically operates to pump just enough air in to cover the first sensor 130. After that, the analytical device 20 works with the sensor arrangement 56 to analyze the calibrant in the reservoir 70 and the oxygen in the air. In other embodiments, the calibrant fluid can be tested separately from the step of testing the air.

Preferably, after the step of sensing the calibration fluid and the air with the cartridge 28, there is a step of allowing the analytical device 20 to automatically seal closed the inlet port 66. This is done by the control system 110 activating the cover control arrangement 82. In particular, the servo motor 114 rotates the shaft 116. This moves the arms 74 to pivot the cover arrangement 72 into sealing engagement with the inlet port 66. This is shown in FIG. 6.

Preferably, after the step of allowing the analytical device 20 to automatically seal closed the inlet port 66, there is a step of allowing the analytical device 20 to automatically pump calibration fluid over the sensor arrangement 56 in the cartridge 28. This is done by the control system 110 and the analytical device 20 activates the pump control arrangement 94. In particular, the servo motor 120 is energized to rotate the shaft 122, which operates the crank 124 and reciprocates the shaft 88 and the plunger 90 in the cartridge 28. The pump arrangement 84, because the inlet port 66 is sealed closed by the cover arrangement 72, draws calibration fluid from the first reservoir 70 across the sensor arrangement 56 (FIG. 6). This leaves calibration fluid over the sensors in the sensor arrangement 56 for the next test. This also ensures that the sample that was being measured, for example blood, is located within the waste chamber 68.

Because the cartridge 28 is reusable, the cartridge 28 is again ready for testing of another sample, such as bodily fluid. This is done by initiating the process with the analytical device 20. Typically, a touch pad or screen is touched on the analytical device 20 by the operator. The inlet port 66 is uncovered by automatic motion of the arm 74 by the analytical device 20. The operator injects the second sample into the cartridge 28 through the inlet port 66. The operator removes the syringe with the sample, and the arm 74 is pivoted back toward the cartridge 28 so that the cover arrangement 72 is covering the inlet port 66. The second sample is measured by the sensor arrangement 56. The inlet port 66 is sealed by movement of the cover arrangement 72 into sealing engagement with the inlet port 66 by automatic motion of the analytical device 20. The analytical device 20 then automatically operates the pump arrangement 84 to draw calibration fluid into the fluid flow path 54 to displace the sample. The sample travels toward the waste chamber 68. The analytical device 20 then automatically lifts the arm 74 to release the seal between the cover arrangement 72 and the injection port 66 to vent the injection port 66. The pump arrangement is then automatically operated by the analytical device to just enough air in through the inlet port 66 and cover the oxygen sensor 130. Air is then measured with the oxygen sensor 130 and the calibration fluid is measured with the other sensors in the sensor arrangement 56. The arm 74 is again closed to seal the inlet port 66, automatically by the analytical device, and the pump arrangement 84 is again automatically actuated by the analytical device 20 to pump the calibration fluid from the reservoir 70 through the fluid channel 54. This leaves the calibration fluid over the sensor arrangement 56 for the next test and makes sure that the bodily fluid is deposited in the waste chamber 68.

As can be appreciated, the analytical device 20 and cartridge 28 have advantages over the arrangement described in U.S. Pat. No. 5,968,329. In the arrangement disclosed herein, there is very little operator interaction required. In particular, once the operator injects the sample to be measured through the inlet port 66, the system completely takes over and automatically manipulates the fluid through the cartridge 28. The cartridge 28 is set up for receiving multiple fluid samples to be tested. The cartridge 28 can also be removed from the analytical device 20, and the single use cartridge 40 can be plugged into the receiving area 30 with a bodily fluid to be tested.

The single-use cartridge 40 may also be run by the automated process described above with respect to the reusable cartridge 28. That is, after inserting the single-use cartridge 40 into the device 20, the system can completely take over and automatically manipulate fluid through the single use cartridge 40.

In certain embodiments, the analytical device 20 has more than a single port. In these embodiments, it is possible to run more than one cartridge (whether the cartridge is a multi-use cartridge 28 or a single-use cartridge 40) simultaneously or separately on the analytical device 20. Each of the cartridges (multi-use 28 and single-use 40) may be run by either automated process or manual processing.

What is claimed is:

1. A system for analyzing a bodily fluid; system comprising:
(a) an analytical device including:
(i) at least one cartridge-receiving receptacle;
(b) a multiple-use cartridge operatively and removably mounted in said cartridge-receiving receptacle; said multiple-use cartridge including:
(i) a base structure defining a fluid channel;
(ii) a sensor arrangement oriented within said fluid channel;
(iii) said base structure defining a inlet port in fluid communication with said fluid channel;
(iv) a pump in fluid communication with said fluid channel;
(c) said analytical device including a pump control arrangement to selectively operate said pump;
(d) said multiple-use cartridge being removable from said cartridge-receiving receptacle; and
(e) said analytical device being configured to receive a single-use, disposable cartridge having a sensor arrangement.

2. A system according to claim 1 wherein:
(a) said multiple-use cartridge includes a cover to selectively open and close said inlet port; and
(b) said analytical device includes a cover control arrangement to manipulate said cover on said multiple-use cartridge to selectively open and close the inlet port on said multiple-use cartridge.

3. A system according to claim 2 wherein:
(a) said pump control arrangement in said analytical device includes a first servo motor controlling pumping action of said pump; and
(b) said cover control arrangement includes a second servo motor controlling operation of said cover.

4. A system according to claim 3 wherein:
(a) said cover control arrangement includes an arm in selectively moveable engagement with said inlet port.

5. A system according to claim 4 wherein:
(a) said cover control arrangement includes a rotateable shaft in operable connection with said arm.

6. A system according to claim 4 wherein:
(a) said arm includes a seal member to selectively form a seal with said inlet port.

7. A system according to claim 1 wherein:
(a) said base structure defines a first reservoir and a second reservoir in fluid communication with said fluid channel;
(i) said multiple-use cartridge sensor arrangement being downstream of said inlet port;
(ii) said first reservoir being upstream of said fluid inlet port and said multiple-use cartridge sensor arrangement;
(iii) said second reservoir being downstream of said inlet port and said multiple-use cartridge sensor arrangement; and
(iv) said pump being downstream of said multiple-use cartridge sensor arrangement and upstream of said second reservoir.

8. A system according to claim 7 further including:
(a) a first valve in said fluid path to prevent fluid flow from said inlet port to said first reservoir;
(b) a second valve in said fluid path to prevent fluid flow from said pump to said multiple-use cartridge sensor arrangement; and
(c) a third valve in said fluid path to prevent flow from said second reservoir to said pump.

9. A system according to claim 1 wherein:
(a) said multiple-use cartridge sensor arrangement includes:
(i) at least one enzymatic sensor;
(ii) at least one amperometric sensor; and
(iii) at least one ion selective electrode sensor.

10. A system according to claim 1 wherein:
(a) said multiple-use cartridge sensor arrangement includes an oxygen sensor.

11. A system according to claim 1 wherein:
(a) said at least one cartridge-receiving receptacle receives, separately, both said multiple-use cartridge and said single-use disposable cartridge.

12. A system according to claim 5 wherein:
(a) said base structure defines a first reservoir and a second reservoir in fluid communication with said fluid channel;
(i) said multiple-use cartridge sensor arrangement being downstream of said inlet port;
(ii) said first reservoir being upstream of said fluid inlet port and said multiple-use cartridge sensor arrangement;
(iii) said second reservoir being downstream of said inlet port and said multiple-use cartridge sensor arrangement; and
(iv) said pump being downstream of said multiple-use cartridge sensor arrangement and upstream of said second reservoir;
(b) a first valve in said fluid path to prevent fluid flow from said inlet port to said first reservoir;
(c) a second valve in said fluid path to prevent fluid flow from said pump to said multiple-use cartridge sensor arrangement;
(d) a third valve in said fluid path to prevent flow from said second reservoir to said pump; and
(e) said multiple-use cartridge sensor arrangement includes:
(i) at least one enzymatic sensor;
(ii) at least one amperometric sensor;
(iii) at least one ion selective electrode sensor; and
(iv) an oxygen sensor.

13. A method of analyzing bodily fluid; the method comprising:
(a) operably inserting a first cartridge into an analytical device; the first cartridge including a fluid inlet port;
(b) dispensing a first sample of bodily fluid into the fluid inlet port;
(c) sensing the bodily fluid with the first cartridge;
(d) allowing the analytical device to automatically pump a calibration fluid over sensors in the first cartridge;
(e) re-using the first cartridge to analyze a second sample of bodily fluid;
(f) operably inserting a second, single-use cartridge into the analytical device; and
(g) using the second, single-use cartridge to analyze a third sample of bodily fluid.

14. A method according to claim 13 further comprising:
(a) after said step of dispensing, allowing the analytical device to automatically cover the fluid inlet port.

15. A method according to claim 14 wherein:
(a) said step of allowing the analytical device to automatically cover the fluid inlet port includes allowing the analytical device to automatically seal closed the fluid inlet port.

16. A method according to claim 15 further comprising:
(a) after said step of sensing, allowing the analytical device to automatically vent the fluid inlet port.

17. A method according to claim 16 wherein:
(a) said step of allowing the analytical device to automatically cover the fluid inlet port includes allowing the analytical device to automatically move an arm into sealing engagement with the fluid inlet port.

18. A method according to claim 17 wherein:
(a) said step of allowing the analytical device to automatically vent the fluid inlet port includes allowing the analytical device to automatically move the arm out of sealing engagement with the fluid inlet port a distance sufficient to vent the fluid inlet port and still cover the fluid inlet port.

19. A method according to claim 15 further comprising:
(a) after said step of allowing the analytical device to automatically pump a calibration fluid over the sensors in the first cartridge, allowing the analytical device to automatically vent the fluid inlet port; and then,
(b) allowing the analytical device to automatically pump air into the fluid inlet port; and then
(c) sensing the calibration fluid and the air with the first cartridge.

20. A method according to claim 19 further comprising:
(a) after said step of sensing the calibration fluid and the air with the first cartridge, allowing the analytical device to automatically seal closed the fluid inlet port; and then
(b) allowing the analytical device to automatically pump calibration fluid over sensors in the first cartridge.

21. A method according to claim 13 further comprising:
(a) before said step of operably inserting a second, single-use cartridge into the analytical device, removing the first cartridge from the analytical device.

23. A method according to claim 21 wherein:
(a) said step of operably inserting a second, single-use cartridge into the analytical device includes inserting the second, single-use cartridge into a same receptacle in the analytical device that held the first cartridge.
